(19) United States
(12) Patent Application Publication
(10) Pub. No.: US 2015/0198237 A1
(43) Pub. Date: Jul. 16, 2015

(54) Floater

(71) Applicant: Rudolph Edward Smith, JR., Palm Bay, FL (US)

(72) Inventor: Rudolph Edward Smith, JR., Palm Bay, FL (US)

(21) Appl. No.: 14/152,887

(22) Filed: Jan. 10, 2014

(51) Int. Cl. F16H 59/02; G05G 1/06; F16H 59/04

(52) U.S. Cl. CPC F16H 59/0278; F16H 59/04; G05G 1/06

(57) ABSTRACT

One embodiment of a thick tubular lever for transmission gear placement and of the type having at one end a cone shape (2) which communicates with the shifter knob at the opposite end. The base (2), (5) of the lever is made of a solid material so that it won't bend. In addition, it has two cavities (6) with accommodating medallions (1) to access mounting screws. Mounting screws protrude vertically through base (2), (5) into factory air valve (4) for secure mounting.

### BRIEF DESCRIPTION OF DRAWINGS

FIG. 1 is a front view showing the shifter assembled with medallion covering the screw access cavity.

FIG. 2 is a side view showing the shifter with exploded views of the medallion unattached showing how the base mounts directly to the factory air valve.

### DETAILED DESCRIPTION OF PREFERRED EMBODIMENTS

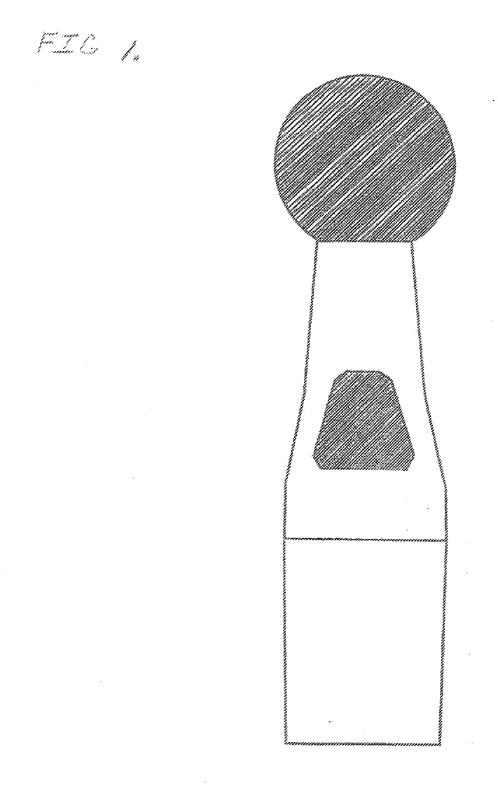

FIG. 1 shows the shifter attached to an air valve 4 with a medallion 1 in place concealing a cavity 6 that provides screw access.

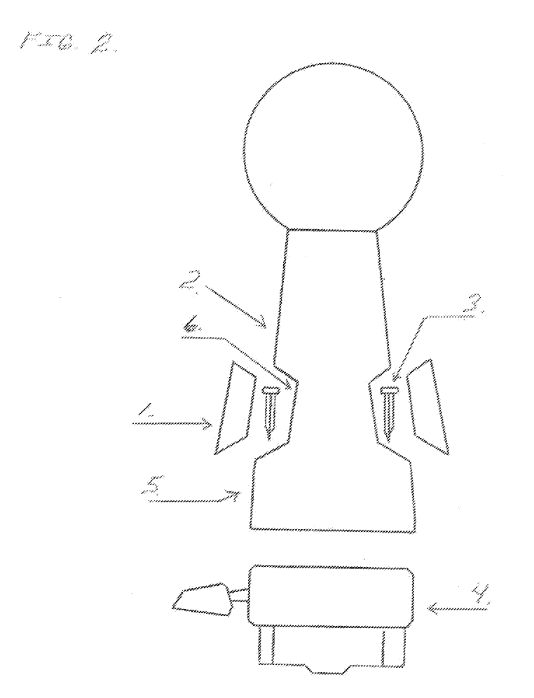

FIG. 2 shows a shifter base 2 attached directly to the factory air valve 4 using factory screws inserted vertically through a base 5. The circular mounting base 5 allows the shifter to directly attach to the factory air valve 4. In contrast, other shifters (prior art) attach to the factory air valve by using a mounting adapter with additional hardware that attaches to the factory air valve. The base of these shifters attaches to the mounting adapter. The mounting procedure of this shifter is much simpler, contains no additional hardware or other parts to rattle around when shifting. The medallion 1 covers the screw access cavity 6 concealing the mounting screws 3. Prior art generally does not cover the mounting screws or uses a mounting adapter.

I presently contemplate the shifter base 2 having a circular knob attached directly to it. However, various other shapes may be used such as oval, triangular, rectangular, square, etc. Moreover, the knob may be permanently affixed to the base 2 or may be removable. I presently contemplate the shifter being constructed of aluminum or plastic. However, the shifter may be constructed of other metals or wood. The medallion 1 may be constructed of the same material as the base 2 or may be constructed out of a contrasting material.

### ADVANTAGES

From the description above, a number of advantages of some embodiments of my shifter become evident:
(a) Because the shifter uses screws inserted vertically through the base, the screws will not vibrate or loosen during shifting.
(b) The shifter does not contain additional parts to mount the base to the factory air valve; consequently, there are no additional parts that can rattle or become loose during shifting.
(c) Because there are no additional parts to mount, the shifter can be mounted to the factory air valve quickly and effortlessly.
(d) Because the base is one unit, the shifter is more durable and stable than other shifters that have multiple components.
(e) The single unit base and the numerous possible knob configurations permit a variety of hand placement options while shifting.
(f) The attachment of the base.by inserting screws vertically eliminates horizontal or angled screw patterns that are more likely to vibrate and loosen during shifting exposing internal components that can cause bodily harm during an accident.

I claim:

1. A gear shift knob to be affixed to Class 8 external transmission positioning lever/stick, the improvement wherein said shifter's base attaches directly to the factory air valve and is capable of using the same screws that mount to a factory shifter.

2. Said knob consists of a contoured head and base and said base has cavities that provide screw access wherein said cavities have a medallion that conceals the mounting screws when inserted into said cavities.

3. Said base has a circular mounting base that attaches to the factory air valve by use of screws inserted vertically through said base.
